(19) United States
(12) Patent Application Publication
(10) Pub. No.: US 2016/0179471 A1
(43) Pub. Date: Jun. 23, 2016

(54) MINIMIZING PROCESSING LOAD WHEN SOLVING MAXIMUM SATISFIABILITY PROBLEM

(71) Applicant: International Business Machines Corporation, Armonk, NY (US)

(72) Inventors: Takeharu SHIRAGA, Fukuoka-Shi (JP); Hiroki YANAGISAWA, Tokyo (JP)

(21) Appl. No.: 14/974,330

(22) Filed: Dec. 18, 2015

(30) Foreign Application Priority Data
Dec. 19, 2014 (JP) 2014-257219

(51) Int. Cl. G06F 7/544

(52) U.S. Cl. CPC G06F 7/5443

(57) ABSTRACT

Provided is a processing apparatus that processes a problem for minimizing the sum of weights respectively associated with clauses that each become false, of a plurality of clauses each based on at least one logical variable, the processing apparatus including: a calculation unit for calculating a boundary value of the sum of the weights in a case where it is assumed that a first logical variable and a second logical variable have a predetermined logical relation; and a replacement unit for replacing the first logical variable in each of the plurality of clauses with a logical expression formed by using the second logical variable, in a case where the boundary value satisfies a predetermined condition.

### CROSS-REFERENCE TO RELATED APPLICATIONS

This application is based upon and claims priority from Japanese Patent Application Number 2014-257219, filed on Dec. 19, 2014, the entire disclosure of each application is incorporated by reference in its entirety.

### BACKGROUND

A maximum satisfiability problem (MAX SAT) is the problem to find an assignment to logical variables that maximizes the weight sum of a plurality of satisfied logical expressions (clauses) including a plurality of logical variables. The MAX SAT can be solved according to a branch-and-bound method including: assigning a logical value to the logical variables to generate child problems; and recursively solving the child problems.

Unfortunately, as the size of a problem becomes larger, the number of child problems generated by the branch-and-bound method exponentially increases, and hence a larger amount of processing resource is required to obtain an optimum solution. In view of this, a technique of a simplification process on child problems, which is called Inference Rule, is proposed to reduce the amount of process.

### SUMMARY OF INVENTION

Unfortunately, only Inference Rule in which a unique logical value is assigned to each logical variable in the case where a predetermined condition is established is known up to now, and a new simplification technique is necessary to further reduce a processing load of solving the maximum satisfiability problem.

According to a first aspect of the present invention, provided is a processing apparatus that processes a problem for maximizing a sum of weights respectively associated with clauses that each take a predetermined logical value, of a plurality of clauses each based on at least one logical variable, the processing apparatus including: a calculation unit for calculating boundary values of the sum of the weights in a case where it is assumed that a first logical variable and a second logical variable have a predetermined logical relation; and a replacement unit for replacing the first logical variable in each of the plurality of clauses with a clause formed by using the second logical variable, in a case where the boundary values satisfy a predetermined condition. Further provided are a processing method using the processing apparatus and a program used for the processing apparatus.

Note that features of the present invention are not entirely listed above in the summary of the invention. Moreover, sub-combinations of these feature groups can also be included in the present invention.

### BRIEF DESCRIPTION OF DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 illustrates a block diagram of a processing apparatus 10 according to the present embodiment;

FIG. 2 illustrates an example of a branch-and-bound process;

FIG. 3 schematically illustrates a simplification process according to the present embodiment;

FIG. 4 illustrates a processing flow by the processing apparatus 10 of the present embodiment;

FIG. 5 illustrates an example of a specific processing content of S300;

FIG. 6 illustrates an example of a specific processing content of S330;

FIG. 7 schematically illustrates a first simplification process according to the present embodiment;

FIG. 8 illustrates an example of a specific processing content of S350;

FIG. 9 illustrates an example of a maximum satisfiability problem as a target of the present embodiment;

FIG. 10 illustrates an example of a second simplification process according to the present embodiment; and

FIG. 11 illustrates an example of a hardware configuration of a computer 1900.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The terminology used herein is for the purpose of describing particular embodiments only and is not intended to be limiting of the invention.

An embodiment of the present invention is explained below with reference to the drawings. Throughout the drawings referred to below, the same reference numerals and signs denote the same targets unless specifically noted otherwise. Please understand that the embodiment of the present invention is an embodiment for explaining a preferred mode of the present invention and is not intended to limit the scope of the present invention to the scope explained in the embodiment.

Hereinafter, the present invention is described through an embodiment of the invention, and the following embodiment is not intended to limit inventions according to the scope of claims. Moreover, all combinations of features described in the embodiment are not necessarily essential to solving means of the invention.

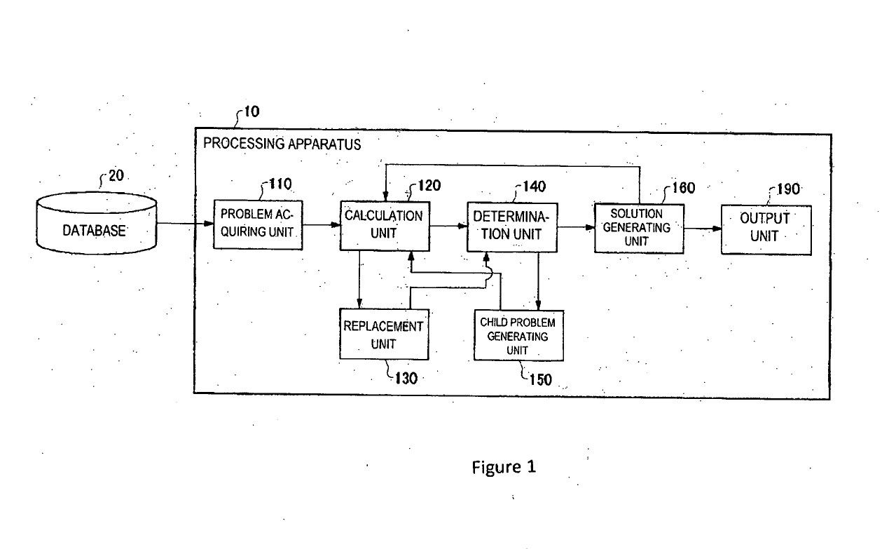

FIG. 1 illustrates a block diagram of a processing apparatus 10 according to the present embodiment. The processing apparatus 10 processes a problem for maximizing the sum of weights respectively associated with clauses that each take a predetermined logical value, of a plurality of clauses.

In the present embodiment, it is assumed that the processing apparatus 10 solves a problem for minimizing the sum of the weights of clauses that each take a first logical value (for example, false). This problem is synonymous with a problem for maximizing the weight sum of clauses that each take a second logical value (for example, true) as the negation of the first logical value. The processing apparatus 10 includes a problem acquiring unit 110, a calculation unit 120, a replacement unit 130, a determination unit 140, a child problem generating unit 150, a solution generating unit 160, and an output unit 190.

The problem acquiring unit 110 acquires a problem as a processing target of the processing apparatus 10. For example, the problem acquiring unit 110 acquires a maximum satisfiability problem including a plurality of clauses from a database 20 or the like, the clauses being each based on at least one logical variable and each having a weight. The problem acquiring unit 110 supplies the acquired problem to the calculation unit 120.

The calculation unit 120 calculates boundary values of the sum of weights that are obtained from the problem under a predetermined condition, in order to determine whether or not the problem can be simplified. For example, the calculation unit 120 calculates boundary values of the sum of the weights of the clauses that each take the predetermined logical value (for example, the first logical value) in the case where it is assumed that the first logical variable and the second logical variable included in the plurality of clauses of the problem have a predetermined logical relation (for example, the first logical variable # the second logical variable). The calculation unit 120 calculates boundary values also for child problems derived from the problem. The calculation unit 120 supplies the calculated boundary values to the replacement unit 130.

Moreover, the calculation unit 120 calculates: an overall lower bound value of the sum of the weights of the plurality of clauses for the overall problem that takes the predetermined logical value (for example, the first logical value) for each child problem; and an overall upper bound value of the sum of the weights of the plurality of clauses for the overall problem as of processing. The calculation unit 120 supplies the overall upper bound value and the overall lower bound value to the replacement unit 130 and the determination unit 140. A more specific operation of the calculation unit 120 is described later.

In the case where the boundary values, the overall upper bound value, and/or the overall lower bound value satisfy a predetermined condition, the replacement unit 130 replaces the logical variables in the plurality of clauses with a logical expression formed by using other logical variables. Consequently, the replacement unit 130 reduces the number of the logical variables included in the clauses of the child problem, and simplifies the child problem. The replacement unit 130 may simplify the child problem by applying conventional Inference Rule. The replacement unit 130 supplies the simplified child problem or the child problem that has been failed in the simplification, to the determination unit 140. A more specific operation of the replacement unit 130 is described later.

The determination unit 140 determines whether or not an optimum solution to the child problem can be generated. For example, in the case where the size of the child problem is smaller than a predetermined threshold, the determination unit 140 determines that an optimum solution to the child problem can be obtained by using a brute force search. In the case where the determination unit 140 determines that the solutions can be obtained, the determination unit 140 supplies the child problem to the solution generating unit 160. In the case where the determination unit 140 determines that the optimum solution cannot be obtained, the determination unit 140 supplies the child problem to the child problem generating unit 150.

The child problem generating unit 150 generates new child problems from the given child problem. For example, the child problem generating unit 150 selects one logical variable from the plurality of logical variables included in the plurality of clauses of the child problem, and assigns a logical value to the selected logical variable. Then, on the basis of a result obtained by this assignment, the child problem generating unit 150 generates child problems not including the selected logical variable. The child problem generating unit 150 provides the generated child problems to the calculation unit 120.

The solution generating unit 160 solves the child problem. For example, the solution generating unit 160 executes all combinations of one or more logical variables included in the child problem, and acquires a combination of logical variables that gives the best sum of weights, as an optimum solution to the child problem. The solution generating unit 160 updates a current best solution, in accordance with the acquired solution. The solution generating unit 160 supplies the updated current best solution to the calculation unit 120 and the output unit 190.

The output unit 190 outputs the best solution of the solutions generated by the solution generating unit 160, as a solution to the maximum satisfiability problem.

As described above, in response to determination that the child problem can be simplified, the processing apparatus 10 replaces the logical variables in the child problem with a logical expression formed by using other logical variables. Consequently, the processing apparatus 10 can efficiently process the child problems, and can solve the maximum satisfiability problem using smaller processing resource.

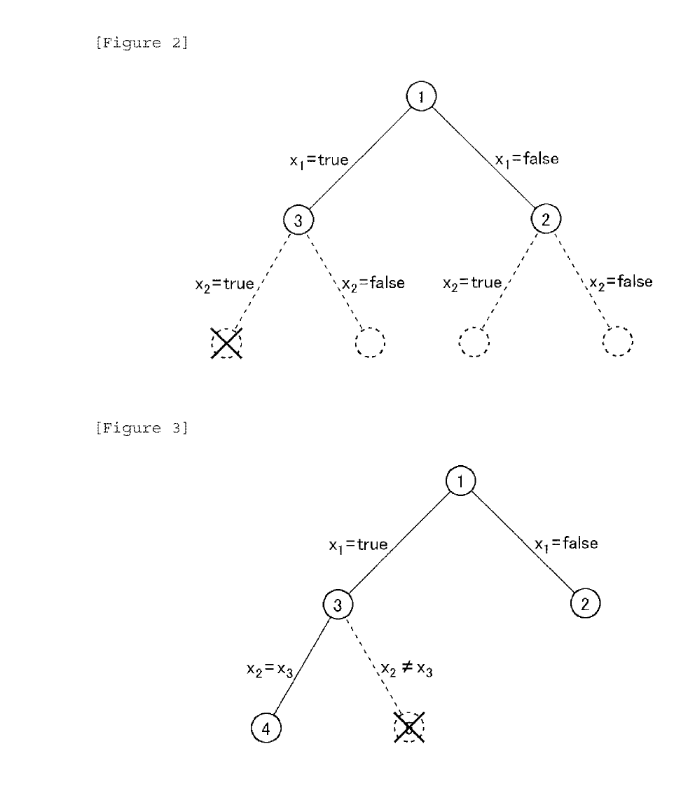

FIG. 2 illustrates an example of a branch-and-bound process. Node 1 in FIG. 2 represents an original problem acquired by the problem acquiring unit 110, and Node 2 and Node 3 therein respectively represent child problems that are generated from the original problem by the child problem generating unit 150. For example, the child problem generating unit 150 assigns false to x₁ of the logical variables included in the original problem to thereby generate a child problem 2 at the node 2, and assigns true to x₁ thereof to thereby generate a child problem 3 at the node 3.

As an example, it is assumed that the original maximum satisfiability problem includes four expressions of a first clause (x₁ [symbol] [symbol] x₂ [symbol] x₃, 3), a second clause (x₂ [symbol] x₃, 2), a third clause ( [symbol] x₁ [symbol] [symbol] x₃, 4), and a fourth clause (x₃, 1). For example, the first clause means that the first clause having a weight of 3 is satisfied in the case where any of the conditions that x₁ is true, that x₂ is false, and that x₃ is true is established.

In the case where the child problem generating unit 150 assigns true to the logical variable x₁ included in the original problem, the child problem generating unit 150 generates a child problem at the node 3 including three expressions of a second clause (x₂ [symbol] x₃, 2), a third clause ( [symbol] x₃, 4), and the fourth clause (x₃, 1). Here, the first clause of the original problem is always satisfied, and thus does not need to be handled. Accordingly, the child problem generating unit 150 deletes the first clause from the child problems. Moreover, the child problem generating unit 150 deletes [symbol] x₁ that always becomes false, from the third clause.

In a conventional simplification process, a process of giving part of logical values to part of logical variables in a child problem is omitted, whereby a process on the child problem is simplified. For example, in the case where the processing apparatus 10 detects a relation that a logical variable (or the negation of the logical variable) appears in all clauses whereas the negation of the logical variable (or the logical variable) does not appear therein, the processing apparatus 10 assigns true (or false) to the logical variable.

As an example, x₂ appears in the above-mentioned child problem including the three expressions whereas [symbol] x₂ does not appear therein. In such a case, if the second logical value (for example, true) is assigned to x₂, a contribution to a problem for maximizing the second logical value can always be made. Accordingly, if the second logical value (true) is assigned to x₂ in the above-mentioned child problem, a more simplified child problem including two expressions of the third clause ( [symbol] x₃, 4) and the fourth clause (x₃, 1) is generated. This is called Pure Literal Rule.

Moreover, for example, in the case where a weight obtained by assigning the second logical value (for example, true) to an arbitrary logical variable in a unit clause (a clause with single logical variable) is larger than a weight of the another unit clause consisting of the negation of the logical variable, the processing apparatus 10 assigns the second logical value to the arbitrary logical variable. As an example, a weight (4) obtained by giving false to x₃ is larger than a weight (1) obtained by giving true to x₃ in the above-mentioned child problem including only the third clause and the fourth clause, and hence false may be assigned to x₃. This is called Complementary Unit Rule.

In a conventional simplification process, a logical value is assigned to part of logical variables, whereby part of a process on a child problem can be omitted. For example, as illustrated in FIG. 2, in the case where false is assigned to x₂ in the child problem 3 at the node 3 according to Pure Literal Rule or the like, the processing apparatus 10 may continue only a process on the child problem after false is assigned to x₂, and may omit a process on the child problem after true is assigned to x₂.

FIG. 3 schematically illustrates a simplification process according to the present embodiment. In the present embodiment, the processing apparatus 10 performs a simplification process of replacing logical variables in a child problem with other logical variables. In an example of FIG. 3, similarly to FIG. 2, the processing apparatus 10 generates the child problems at the node 2 and the node 3 from the original problem at the node 1, and performs a simplification process on the child problem at the node 3.

Here, for the child problem at the node 3, in the case where the boundary values and the like calculated by the calculation unit 120 satisfy a predetermined condition, the processing apparatus 10 replaces the logical variable x₂ with the logical variable x₃. As a result, the processing apparatus 10 may not need to process a child problem in which different logical values (for example, true and false or false and true) are respectively assigned to the logical variable x₂ and the logical variable x₃, among the child problems. That is, the processing apparatus 10 simplifies the child problem at the node 3 to generate a problem at a node 4 in which the number of logical variables is reduced by one.

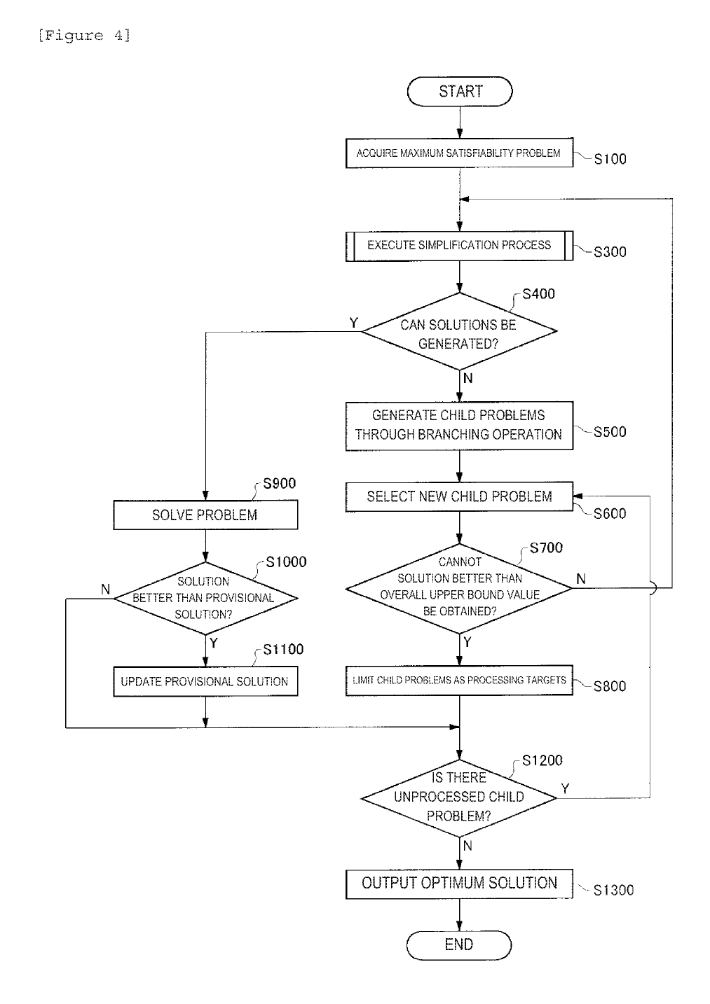

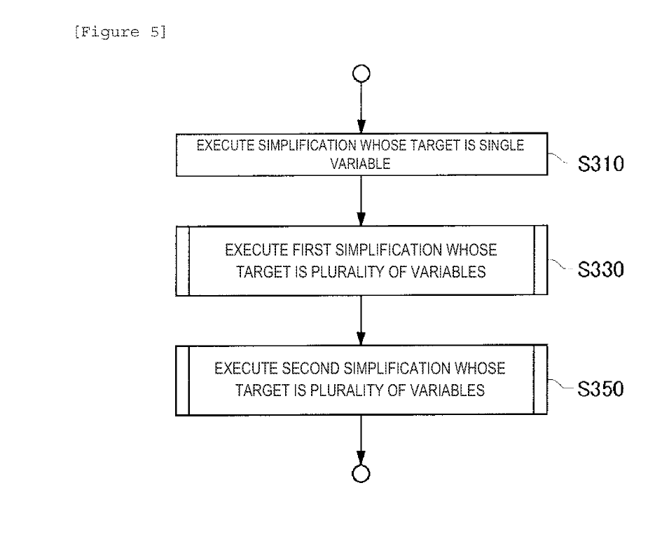

FIG. 4 illustrates a processing flow by the processing apparatus 10 of the present embodiment. In the present embodiment, the processing apparatus 10 executes S100 to S1300 to thereby process a maximum satisfiability problem.

First, in S100, the problem acquiring unit 110 acquires a maximum satisfiability problem including a plurality of clauses as a processing target of the processing apparatus 10. For example, the problem acquiring unit 110 acquires a maximum satisfiability problem for assigning a logical value to logical variables so as to maximize the weight sum of the clauses that each take the second logical value (for example, true). As an example, the problem acquiring unit 110 acquires a problem including weighted clauses, each of the clauses being the logical sum of one or more elements when an arbitrary logical variable or the negation of an arbitrary logical variable is each element.

The problem acquiring unit 110 may acquire a maximum satisfiability problem that is equivalent to the maximum clique problem or the maximum cut problem. The problem acquiring unit 110 supplies the acquired problem to the calculation unit 120.

Subsequently, in S300, the processing apparatus 10 executes a simplification process. For example, in order to determine whether or not the problem acquired in S100 and child problems derived from the acquired problem can be simplified, the calculation unit 120 calculates a boundary value and the like of the sum of weights that is obtained from the child problems under a predetermined condition, and the replacement unit 130 executes simplification of the child problems in accordance with the calculated boundary value and the like.

Here, for example, the replacement unit 130 executes the simplification by replacing the logical variables in the child problem with a logical expression formed by using other logical variables. In the case where the replacement unit 130 executes the simplification process, the replacement unit 130 supplies the simplified child problem to the determination unit 140. In the case where the replacement unit 130 does not execute the simplification process, the replacement unit 130 supplies the child problem to the determination unit 140 without any change. Note that the details of the simplification process are described later.

Subsequently, in S400, the determination unit 140 determines whether or not an optimum solution to the child problem can be found. For example, in the case where the number of the logical variables included in the child problem is equal to or less than a predetermined threshold and/or where the number of the clauses included in the child problem is equal to or less than a predetermined threshold, the determination unit 140 may determine that an optimum solution to the child problems can be obtained.

As an example, in the case where the number of the variables included in all the clauses included in the child problem is one or where the weight sum in the child problem is uniquely determined regardless of logical values of logical variables, the determination unit 140 may determine that an optimum solution to the child problem can be obtained. In the case where the determination unit 140 determines that an optimum solution can be obtained, the determination unit 140 supplies the child problem to the solution generating unit 160. In the case where the determination unit 140 determines that an optimum solution cannot be obtained, the determination unit 140 supplies the child problem to the child problem generating unit 150.

In S500, the child problem generating unit 150 generates new child problems from the child problem. For example, the child problem generating unit 150 selects one logical variable from the plurality of logical variables included in the plurality of clauses of the child problem, and assigns different logical values to the selected logical variable. Then, on the basis of a result obtained by this assignment, the child problem generating unit 150 generates a plurality of child problems not including the selected logical variable.

In the case where a clause is not uniquely determined to be true or false regardless of the other logical variables as a result of assigning logical values to the selected logical variable, the child problem generating unit 150 excludes the selected logical variable from the clause, from the child problem. Moreover, the child problem generating unit 150 may exclude, from the child problem, a clause that is uniquely determined to be true or false regardless of the other logical variables as a result of assigning logical values to the selected logical variable. Moreover, the child problem generating unit 150 provides the generated child problems to the calculation unit 120.

Subsequently, in S600, the calculation unit 120 selects a child problem as a processing target from the unprocessed child problems. For example, the calculation unit 120 may select a child problem from the unprocessed child problems with higher priority being placed on shallow nodes in a search tree. As an example, in the case where the child problems at the node 2 and the node 4 exist as the unprocessed child problems in FIG. 3, the calculation unit 120 may select the child problem at the node 2 in a shallower layer with higher priority. Alternatively, the calculation unit 120 may select a child problem from the unprocessed child problems with higher priority being placed on deeper nodes in the search tree.

Here, the calculation unit 120 calculates: an overall lower bound value LB of the sum of weights for the overall problem that takes the predetermined logical value (for example, the first logical value) for the selected child problem; and an overall upper bound value UB of the sum of the weights of the plurality of clauses for the overall problem.

That is, the processing apparatus 10 estimates the range of the weight sum of the clauses that each take the first logical value, which is possible in the case of optimum assignment in the course of solving a problem for maximizing the second logical value or minimizing the first logical value while branching the problem into child problems. Here, a value in the best case in the range of the sum of the first logical value estimated for the selected child problem is the overall lower bound value LB. In the case where the weight sum of the clauses that each take the first logical value (or the second logical value) is uniquely determined for the selected child problem, a value of the unique weight sum is the overall lower bound value LB. The overall lower bound value LB is calculated for each child problem.

Moreover, a value in the worst case in the range of the sum of the first logical value that can be obtained from the optimum solution known so far is the overall upper bound value UB. The overall upper bound value UB is a global value common to all the child problems. In the case where a candidate of a value of the overall upper bound value UB calculated for a child problem is better than the current overall upper bound value UB, the processing apparatus 10 updates the overall upper bound value UB with the candidate of the calculated value of the overall upper bound value UB.

For example, the following case is discussed. That is, in S600, the calculation unit 120 selects a child problem generated by assigning true to the logical variable x₁ in an original problem including a first clause ( [symbol] x₁, 3), a second clause (x₂ [symbol] x₃, 2), a third clause (x₁ [symbol] x₃, 4), and a fourth clause (x₃, 1), the child problem including three expressions of a second clause (x₂ [symbol] x₃, 2), a third clause ( [symbol] x₃, 4), and the fourth clause (x₃, 1).

In this case, because the first clause is always unsatisfied, the sum of the weights of the clauses that each take the first logical value (for example, false) for the overall problem is at least 3. Accordingly, the calculation unit 120 calculates the overall lower bound value LB as 3 for the selected child problem.

Moreover, because the third clause is always satisfied, the maximum value of the sum of the weights of the clauses that each take the first logical value (for example, false) for the overall problem when the problem is branched into child problems is 6 (3+2+1). Here, if the calculated maximum value is smaller than the current overall upper bound value UB, the calculation unit 120 updates the overall upper bound value UB with the calculated maximum value.

This is for the following reason. That is, because the overall upper bound value UB is the weight sum of the first logical value that can be obtained from the optimum solution even in the worst case (the case where the weight sum of the clauses that each take the first logical value becomes largest) for the overall problem, the overall upper bound value UB does not need to be updated in the case where the calculated maximum value is larger than the current overall upper bound value UB (that is, the case where the weight sum of the first logical value obtained from the worst optimum solution obtained for the child problem is not better than the weight sum of the first logical value obtained from the worst optimum solution obtained for the overall problem).

Subsequently, in S700, the calculation unit 120 determines whether or not the overall lower bound value LB obtained for the selected child problem is better than the current overall upper bound value UB. For example, in the case where the overall lower bound value LB is smaller than the current overall upper bound value UB, the calculation unit 120 returns the process to S300. In the case where the overall lower bound value LB is larger than the current overall upper bound value UB, the calculation unit 120 proceeds the process to S800. In this way, the processing apparatus 10 tries a simplification process on the child problem.

In S800, the calculation unit 120 defines the selected child problem as a processed child problem. Consequently, the processing apparatus 10 stops processing the child problem for which the overall lower bound value LB is smaller than the current overall upper bound value UB (that is, the child problem to which the optimum solution cannot be obtained), and hence the processing resource can be saved. The processing apparatus 10 proceeds the process to S1200.

In S900, the solution generating unit 160 solves the child problem. For example, the solution generating unit 160 executes all unique combinations of one or more logical variables included in each child problem, and acquires optimum assignment of logical values to logical variables as an optimum solution to the child problem, the assignment giving the largest sum of the weights of the clauses that each take the second logical value or a smallest sum of the weights of the clauses that each take the first logical value.

In the case where the same weight sum as the overall lower bound value LB of the child problem is obtained during the execution of a combination, the solution generating unit 160 may define assignment concerning the combination as a solution to the child problem, and may terminate the remaining process. In the case where assignment of logical values to the logical variables in the child problem is uniquely determined (for example, the case where the child problem includes one clause including only a single logical variable), the solution generating unit 160 acquires a logical value assigned to each logical variable in the child problem, as a solution thereto.

Subsequently, in S1000, the solution generating unit 160 determines whether or not the acquired solution is a solution better than the current best solution. For example, the solution generating unit 160 determines whether or not the weight sum of the clauses that each take the first logical value, based on the acquired solution is smaller than the weight sum thereof based on the current best solution. In the case where the weight sum based on the acquired solution is smaller than the weight sum based on the current best solution, the solution generating unit 160 proceeds the process to S1100. Otherwise, the solution generating unit 160 proceeds the process to S1200.

Subsequently, in S1100, the solution generating unit 160 updates the current best solution. For example, the solution generating unit 160 updates the current best solution with the solution generated in S900. In the case where the current best solution does not exist, the solution generating unit 160 makes such an update that the acquired solution is defined as a new current best solution. In the case where the solution generating unit 160 updates the current best solution, the solution generating unit 160 supplies the updated current best solution to the calculation unit 120.

Here, the solution generating unit 160 also updates the overall upper bound value UB in accordance with the current best solution. For example, in the case where the weight sum of the clauses based on the updated current best solution is smaller than the current overall upper bound value UB, the solution generating unit 160 replaces and updates the overall upper bound value UB with the weight sum of the clauses based on the updated current best solution. The solution generating unit 160 supplies the updated current best solution and the overall upper bound value UB to the calculation unit 120 and the output unit 190. After S1100, the solution generating unit 160 proceeds the process to S1200.

In S1200, the calculation unit 120 determines whether or not the generated child problems include an unprocessed child problem. For example, the calculation unit 120 determines whether or not the child problems that are generated in S500 by the child problem generating unit 150 include a child problem that has not been processed in any of S800 and S900. In the case where the calculation unit 120 determines that there is an unprocessed child problem, the calculation unit 120 returns the process to S600. In the case where the calculation unit 120 determines that there is not an unprocessed child problem, the calculation unit 120 proceeds the process to S1300.

In S1300, the output unit 190 outputs the optimum solution generated by the solution generating unit 160. For example, the output unit 190 displays the current best solution finally obtained from the solution generating unit 160 as the optimum solution onto a display or the like of the processing apparatus 10, and stores the same as the optimum solution into a storage device of the processing apparatus 10.

In this way, the processing apparatus 10 generates the child problems from the original problem acquired by the problem acquiring unit 110. Then, the processing apparatus 10 simplifies the child problems by, for example, replacing the logical variables in the child problems with a logical expression formed by using other logical variables, and recursively solves the simplified child problems, to thereby obtain a solution to the original maximum satisfiability problem. Consequently, the processing apparatus 10 can efficiently process the child problems, and can solve the maximum satisfiability problem using smaller processing resource.

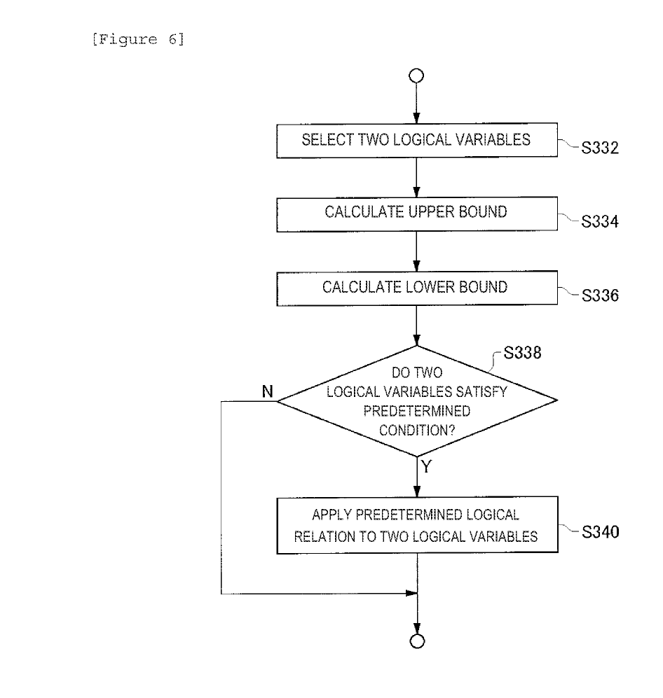

FIG. 5 illustrates an example of a specific processing content of S300 in the processing flow of FIG. 4. In S300, the processing apparatus 10 executes the simplification process on the child problem according to, for example, S310 to S350.

In S310, the processing apparatus 10 executes simplification whose target is a single logical variable, on the child problem. For example, the processing apparatus 10 simplifies the child problem by assigning a predetermined logical value to the logical variables included in the child problem, under a condition that a given condition is satisfied. As an example, the processing apparatus 10 simplifies the child problem by applying Pure Literal Rule and/or Complementary Unit Rule. The processing apparatus 10 may simplify the child problem by applying other existing Inference Rules.

In S330, the processing apparatus 10 executes a first simplification process whose target is a plurality of logical variables. For example, the calculation unit 120 calculates a boundary value for arbitrary combinations of the logical variables included in the child problem, and the replacement unit 130 executes the first simplification process on a combination in which the boundary value satisfies a given condition.

As an example, in the case where the processing apparatus 10 determines that the worst optimum solution obtained when the same logical value is assigned to two logical variables included in the child problem is better than the best optimum solution obtained when different logical values are respectively assigned to the two logical variables, the processing apparatus 10 assigns the same logical value to the two logical variables. The details of the first simplification process are described later.

In S350, the processing apparatus 10 executes a second simplification process whose target is a plurality of logical variables. For example, if it is estimated that the weight sum of the clauses that each take the first logical value, based on the best optimum solution obtained when different logical values are respectively assigned to arbitrary two logical variables included in the child problem is worse than a result of a solution that is estimated at present to be obtained even in the worst case in the future process (that is, the overall upper bound value UB), a process of solving a problem in which different logical values are respectively assigned to the two logical variables is wasteful. Accordingly, in such a case, the processing apparatus 10 assigns the same logical value to the two logical variables. The details of the second simplification process are described later.

In this way, the processing apparatus 10 simplifies the child problem by applying a plurality of types of simplification process. Consequently, the processing apparatus 10 can solve the child problem using smaller processing resource.

Note that the processing apparatus 10 may omit arbitrary one or two of the simplification processes in S310, S330, and S350, and may execute these simplification processes in a different order. For example, the processing apparatus 10 may execute only the process in S330, only the process in S350, or only the processes in S330 and S350.

Moreover, the processing apparatus 10 may repetitively execute the simplification process(es). For example, the processing apparatus 10 may repeat the processes (or part of the processes) in S310 to S350 until a predetermined condition is satisfied.

FIG. 6 illustrates an example of a specific processing content of S330 in the processing flow of FIG. 5. In S330, the calculation unit 120 and the replacement unit 130 of the processing apparatus 10 execute the first simplification process by executing processes in S332 to S340.

First, in S332, the calculation unit 120 selects two logical variables as simplification targets from the plurality of logical variables included in the child problem. For example, the calculation unit 120 may select logical variables that appear a large number of times or logical variables included in clauses having a large weight sum, with higher priority from the plurality of logical variables included in the child problem.

Subsequently, in S334, the calculation unit 120 calculates an upper bound value of the sum of the weights respectively associated with the clauses of the child problem as the processing targets, the clauses each taking the first logical value in the case where it is assumed that the first logical variable and the second logical variable do not have the predetermined logical relation (for example, the first logical variable # the second logical variable) (for example, in the case where it is assumed that the first logical variable=the second logical variable).

For example, in each of the cases of assigning combinations of values of the first logical variable and the second logical variable (that is, the case where the first logical variable and the second logical variable are both true or both false) in the case where the first logical variable and the second logical variable have an equal logical relation, the calculation unit 120 calculates an upper value of the sum of the weights respectively associated with the clauses that can become false, and calculates the minimum value of the calculated upper values as the upper bound value.

As an example, the calculation unit 120 calculates a first value by subtracting the sum of: the total of the weights of the clauses including the logical sum of the first logical variable and the second logical variable; the total of the weights of the clauses including the logical sum of the negation of the first logical variable and the second logical variable; and the total of the weights of the clauses including the logical sum of the negation of the second logical variable and the first logical variable, from the sum of: the total of the weights of the clauses including the first logical variable; and the total of the weights of the clauses including the second logical variable.

The calculation unit 120 calculates a second value by subtracting the sum of: the total of the weights of the clauses including the logical sum of the negation of the first logical variable and the negation of the second logical variable; the total of the weights of the clauses including the logical sum of the negation of the first logical variable and the second logical variable; and the total of the weights of the clauses including the logical sum of the negation of the second logical variable and the first logical variable, from the sum of: the total of the weights of the clauses including the negation of the first logical variable; and the total of the weights of the clauses including the negation of the second logical variable.

The calculation unit 120 may define the smaller one of the calculated first value and the calculated second value, as the upper bound value. That is, in the case where the first logical variable is expressed as x, where the second logical variable is expressed as y, and where the total of the weights of the clauses including a logical expression A (but not including [symbol] A) in the child problem as the processing targets is expressed as wₐₗₗ(A), the calculation unit 120 can calculate the upper bound value according to the following expression.

min{wₐₗₗ(x)+wₐₗₗ(y)−wₐₗₗ(x [symbol] y),wₐₗₗ( [symbol] x)+wₐₗₗ( [symbol] y)−wₐₗₗ( [symbol] x [symbol] y)}−wₐₗₗ( [symbol] x [symbol] y)−wₐₗₗ(x [symbol] y)

In the case where the first logical variable and the second logical variable have an equal logical relation, the weight sum of the clauses that each take the second logical value, of the child problem does not exceed the upper bound value calculated as described above. That is, the upper bound value calculated as described above corresponds to the weight sum of the clauses that each take the first logical value, based on the optimum solution that is expected to be at least obtained in the case of assigning the equal logical relation to the first logical variable and the second logical variable. The calculation unit 120 supplies the calculated upper bound value to the replacement unit 130.

Subsequently, in S336, the calculation unit 120 calculates a lower bound value of the sum of the weights respectively associated with the clauses of the child problem as the processing targets, the clauses each taking the first logical value in the case where it is assumed that the first logical variable and the second logical variable have the predetermined logical relation (for example, the first logical variable # the second logical variable). For example, in each of combinations of values of the first logical variable and the second logical variable (that is, the case where the first logical variable is true and the second logical variable is false or where the first logical variable is false and the second logical variable is true) in the case where the first logical variable and the second logical variable have an unequal logical relation, the calculation unit 120 calculates a lower value of the sum of the weights respectively associated with the clauses that always become false, and calculates the minimum value of the calculated lower values as the lower bound value.

As an example, the calculation unit 120 calculates a third value that is the sum of: the total of the weights of the clauses that are the negation of the first logical variable; the total of the weights of the clauses that are the second logical variable; and the total of the weights of the clauses that are the logical sum of the negation of the first logical variable and the second logical variable.

Moreover, the calculation unit 120 calculates a fourth value that is the sum of: the total of the weights of the clauses that are the first logical variable; the total of the weights of the clauses that are the negation of the second logical variable; and the total of the weights of the clauses that are the logical sum of the negation of the second logical variable and the first logical variable.

The calculation unit 120 may define the smaller one of the third value and the fourth value, as the lower bound value. That is, in the case where the first logical variable is expressed as x, where the second logical variable is expressed as y, and where the total of the weights of the clauses that are a logical expression A itself (not including clauses that include the logical expression A but are not the logical expression A itself) in the child problem as the processing targets is expressed as wᵤₙᵢₜ(A), the calculation unit 120 can calculate the lower bound value according to the following expression.

min{wᵤₙᵢₜ( [symbol] x)+wᵤₙᵢₜ(y)−wᵤₙᵢₜ( [symbol] x [symbol] y),wᵤₙᵢₜ(x)+wᵤₙᵢₜ( [symbol] y)−wᵤₙᵢₜ(x [symbol] y)}

In the case where the first logical variable and the second logical variable have an unequal logical relation, the weight sum of the clauses that each take the second logical value, of the child problems does not fall below the lower bound value calculated as described above. That is, the lower bound value calculated as described above corresponds to the weight sum of the clauses that each take the first logical value, based on the optimum solution that is expected to be obtained in the best case in the case of assigning the unequal logical relation to the first logical variable and the second logical variable. The calculation unit 120 supplies the calculated lower bound value to the replacement unit 130.

Subsequently, in S338, the replacement unit 130 determines whether or not the two logical variables satisfy a predetermined condition. For example, the replacement unit 130 determines whether or not the upper bound value that is calculated in S334 by the calculation unit 120 is equal to or less than the lower bound value that is calculated in S336 by the calculation unit 120. As an example, the replacement unit 130 determines whether or not Expression 1 is established.

$$min \{ \begin{matrix}{w}_{all} ( x ) + {w}_{all} ( y ) - {w}_{all} ( x ⋁ y ) \\ {w}_{all} ( \overline{x} ) + {w}_{all} ( \overline{y} ) - {w}_{all} ( \overline{x} ⋁ \overline{y} )\end{matrix} , \} - {w}_{all} ( \overline{x} ⋁ y ) - {w}_{all} ( x ⋁ \overline{y} ) \leq min \{ \begin{matrix}{w}_{unit} ( \overline{x} ) + {w}_{unit} ( y ) + {w}_{unit} ( \overline{x} ⋁ y ) \\ {w}_{unit} ( x ) + {w}_{unit} ( \overline{y} ) + {w}_{unit} ( x ⋁ \overline{y} )\end{matrix} , \} \qquad Expression 1$$

In the case where the upper bound value is equal to or less than the lower bound value, the replacement unit 130 proceeds the process to S340. In the case where the upper bound value is more than the lower bound value, the replacement unit 130 ends the process in S330.

In S340, the replacement unit 130 replaces the first logical variable with the logical expression in the case where the first logical variable and the second logical variable do not have the predetermined logical relation (in the case where the first logical variable=the second logical variable). For example, the replacement unit 130 replaces the first logical variable with the second logical variable in the plurality of clauses of the child problem as the processing targets, to thereby update the child problem as the processing target. Consequently, the replacement unit 130 can reduce the number of the logical variables in the child problem as the processing target.

In this way, in the first simplification process, the replacement unit 130 determines whether or not the upper bound value of the weight sum of the clauses that each take the first logical value in the case of assigning the same logical value to the two logical variables is equal to or less than the lower bound value of the weight sum of the clauses that each take the first logical value in the case of respectively assigning different logical values thereto. In the case where the determination result is affirmative, assignment of a logical relation (for example, the first logical variable=the second logical variable) that is not the predetermined logical relation in the child problem can certainly lead to a better solution. Hence, the replacement unit 130 applies a logical relation that is not the predetermined logical relation, to the first logical variable and the second logical variable.

Note that, in S330, the processing apparatus 10 may execute the processes in S332 to S340 a plurality of number of times. For example, the processing apparatus 10 may apply the processes in S332 to S340 to an arbitrary pair of logical variables included in the child problem as the processing target, to sequentially update the child problem. In the case where the process in S340 cannot be applied (that is, the case where the determination result in S338 is negative), the processing apparatus 10 may start the processes in S332 to S340 on a pair of other unselected logical variables included in the child problem.

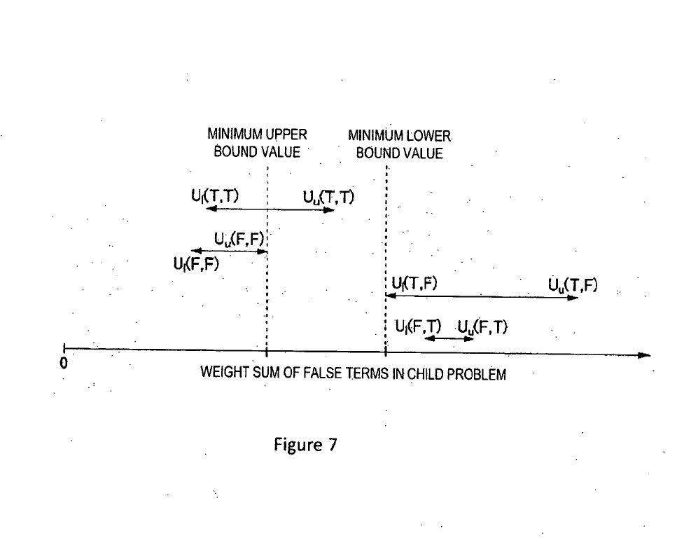

FIG. 7 schematically illustrates the first simplification process according to the present embodiment. The horizontal axis in FIG. 7 represents the sum of the weights of the clauses that each become false, of the clauses included in the child problem. Uₗ(X, Y) in FIG. 7 represents a lower bound value of the weight sum of the clauses of the child problems, the clauses each becoming false in the case of assigning a logical value X to the first logical variable x and assigning a logical value Y to the second logical variable x in the child problems. Uᵤ(X, Y) in FIG. 7 represents an upper bound value of the weight sum of the clauses of the child problem, the clauses each becoming false in the case of assigning the logical value X to the first logical variable x and assigning the logical value Y to the second logical variable y in the child problem.

Accordingly, Uᵤ(T, T) is the upper bound of the weight sum of the clauses that each become false (take the first logical value) in the case where the first logical variable and the second logical variable are both true, and corresponds to the first value that is calculated in S334 by the calculation unit 120. Uᵤ(F, F) is the upper bound of the weight sum of the clauses that each become false (take the first logical value) in the case where the first logical variable and the second logical variable are both false, and corresponds to the second value that is calculated in S334 by the calculation unit 120. The calculation unit 120 calculates the minimum value (the minimum upper bound value in FIG. 7) of Uᵤ(T, T) and Uᵤ(F, F) as the upper bound value.

Uₗ(T, F) in FIG. 7 is the lower bound of the weight sum of the clauses that each become false (take the first logical value) in the case where the first logical variable is true and where the second logical variable is false, and corresponds to the third value that is calculated in S336 by the calculation unit 120. Uₗ(F, T) is the lower bound of the weight sum of the clauses that each become false (take the first logical value) in the case where the first logical variable is false and where the second logical variable is true, and corresponds to the fourth value that is calculated in S336 by the calculation unit 120. The calculation unit 120 calculates the minimum value (the minimum lower bound value in FIG. 7) of Uₗ(T, F) and Uₗ(F, T) as the lower bound value.

In S338, the replacement unit 130 compares the minimum value (in FIG. 7, Uᵤ(F, F)) of Uᵤ(T, T) and Uᵤ(F, F) with the minimum value (in FIG. 7, Uₗ(T, F)) of Uₗ(T, F) and Uₗ(F, T).

The minimum value of Uᵤ(T, T) and Uᵤ(F, F) is a value of the weight sum of the clauses that each become false in the worst case (the case where the weight sum of the clauses that each become false becomes largest) at the time of assigning the same logical value to the first logical variable and the second logical variable in the child problem. The minimum value of Uₗ(T, F) and Uₗ(F, T) is a value of the weight sum of the clauses that each become false in the best case (the case where the weight sum of the clauses that each become false becomes smallest) at the time of assigning the same logical value to the first logical variable and the second logical variable in the child problem. Accordingly, in the case where the former is smaller, assignment of the same logical value to the first logical variable and the second logical variable can certainly lead to a better solution. Hence, in S340, the replacement unit 130 replaces the first logical variable with the second logical variable.

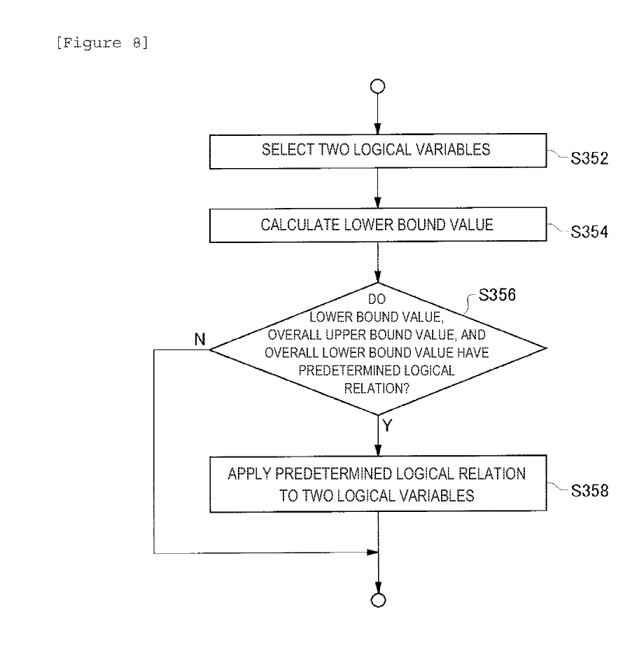

FIG. 8 illustrates an example of a specific processing content of S350 in the processing flow of FIG. 5. In S350, the calculation unit 120 and the replacement unit 130 of the processing apparatus 10 executes the second simplification process by executing processes in S352 to S358.

First, in S352, the calculation unit 120 selects two logical variables as simplification targets from the plurality of logical variables included in the child problem. The calculation unit 120 may select the logical variables according to a method similar to that in S332.

Subsequently, in S354, the calculation unit 120 calculates, for the child problem, a lower bound value of the sum of the weights respectively associated with the clauses that each take the first logical value in the case where it is assumed that the first logical variable and the second logical variable have the predetermined logical relation (for example, the first logical variable≠ the second logical variable). For example, the calculation unit 120 may calculate the lower bound value for the child problem according to a method similar to that in S336.

Subsequently, in S356, the replacement unit 130 determines whether or not the lower bound value for the child problem, the overall upper bound value UB for the overall problem, and the overall lower bound value LB for the overall problem satisfy a predetermined condition. For example, the replacement unit 130 determines whether or not the difference between the overall upper bound value UB and the overall lower bound value LB is equal to or less than the lower bound value for the child problem that is calculated in S354 by the calculation unit 120. As an example, the replacement unit 130 determines whether or not Expression 2 is established.

$$UB - LB \leq min \{ \begin{matrix}{w}_{unit} ( \overline{x} ) + {w}_{unit} ( y ) + {w}_{unit} ( \overline{x} ⋁ y ) \\ {w}_{unit} ( x ) + {w}_{unit} ( \overline{y} ) + {w}_{unit} ( x ⋁ \overline{y} )\end{matrix} , \} \qquad Expression 2$$

In the case where this condition is established, the replacement unit 130 proceeds the process to S358. In the case where this condition is not established, the replacement unit 130 ends the process in S350.

In S358, the replacement unit 130 replaces the first logical variable with the logical expression in the case where the first logical variable and the second logical variable do not have the predetermined logical relation, for the plurality of clauses included in the child problem as the processing targets. For example, the replacement unit 130 replaces the first logical variable with the second logical variable in the plurality of clauses of the child problem as the processing targets, to thereby update the child problem as the processing targets. Consequently, the replacement unit 130 can reduce the number of the logical variables in the child problem as the processing targets.

In this way, in the second simplification process, the replacement unit 130 simplifies the child problem as the processing target on the basis of the result obtained by comparing the difference between the overall upper bound value UB and the overall lower bound value LB with the lower bound value.

Note that, in S350, the processing apparatus 10 may execute the processes in S352 to S358 a plurality of number of times. For example, the processing apparatus 10 may apply the processes in S352 to S358 to an arbitrary pair of logical variables included in the child problem as the processing target, to sequentially update the child problem. In the case where the process in S358 cannot be applied (that is, the case where the determination result in S356 is negative), the processing apparatus 10 may start the processes in S352 to S358 on another unselected pair of logical variables included in the child problem.

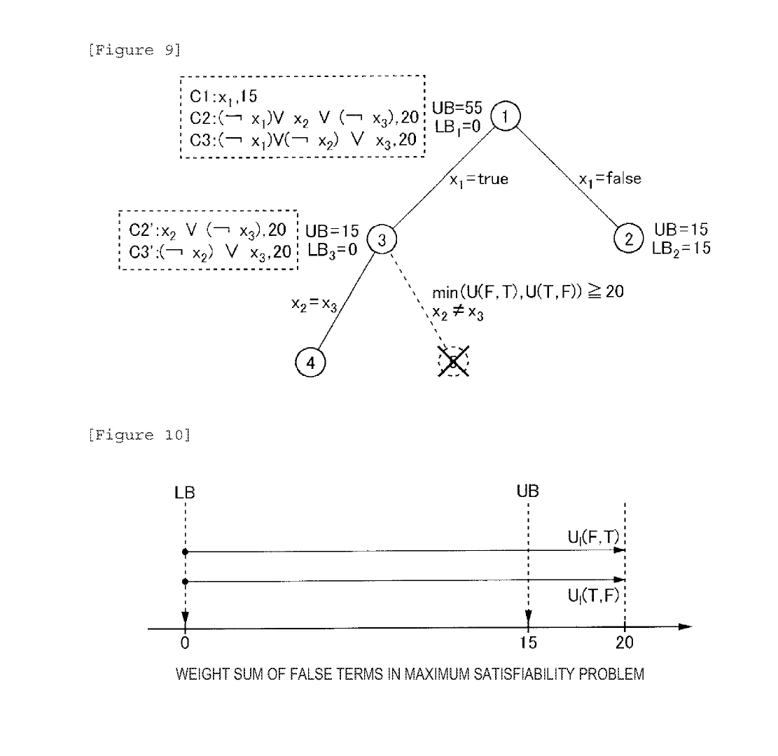

Here, the second simplification process is schematically described with reference to FIG. 9 and FIG. 10. FIG. 9 illustrates an example of the maximum satisfiability problem as a target of the present embodiment. A node 1 in FIG. 9 represents an original problem acquired by the problem acquiring unit 110, and a node 2 and a node 3 therein respectively represent child problems that are generated from the original problem by the child problem generating unit 150.

As an example, it is assumed that the problem acquiring unit 110 acquires, as the original problem, a problem for maximizing the weight sum of clauses that each include a first clause C1 (x₁, 15), a second clause C2 ( [symbol] x₁ [symbol] x₂ [symbol] x₃, 20), and a third clause C3 ( [symbol] x₁ [symbol] x₂ [symbol] x₃, 20) and become true (take the second logical value). At the node 1 of the original problem, all the clauses can become false, and hence the overall upper bound value UB that is the upper bound of the weight sum of the clauses that each become false (take the first logical value) for the overall problem is the weight sum of all the clauses, that is, 55 (15+20+20).

In the original problem, a logical value is not assigned to any of the logical variables. Accordingly, at the node 1 as the processing target, the overall lower bound value LB that is the lower bound of the weight sum of the clauses that each become false (take the first logical value) for the overall problem is 0.

Here, the child problem generating unit 150 assigns false to the logical variable x₁ in the original problem (node 1) to thereby generate a child problem (node 2). As a result of assigning false to the logical variable x₁, only the clause C1 is certainly unsatisfied to become false. The clause C2 and the clause C3 each including “ [symbol] x₁” are certainly satisfied to become true.

Accordingly, the overall lower bound value LB₂ for the overall problem at the node 2 is 15. Moreover, a candidate of a value of the overall upper bound value UB for the overall problem at the node 2 is 15, which is smaller than, that is, better than the current overall upper bound value UB of 55, and hence the calculation unit 120 updates the overall upper bound value UB with 15.

Moreover, the child problem generating unit 150 assigns true to the logical variable x₁ in the original problem (node 1) to thereby generate another child problem (node 3). As a result of assigning true to the logical variable x₁, the clause C1 is satisfied to become true. As a result, the child problem generating unit 150 generates the child problem (node 3) including two expressions of a second clause C2′(x₂ [symbol] x₃, 20) and a third clause C3′( [symbol] x₂ [symbol] x₃, 20).

At the node 3, a clause that is determined to become false does not exist for the overall problem. Accordingly, the overall lower bound value LB₃ for the overall problem at the node 3 is 0. Moreover, at the node 3, both the second clause C2′ and the third clause C3′ can become false. Accordingly, a candidate of a value of the overall upper bound value UB for the overall problem at the node 3 is 40 (20+20), which is larger than the current overall upper bound value UB of 15. Hence, the calculation unit 120 does not update the overall upper bound value UB and holds 15.

Here, the second simplification process is applied to the node 3 with the first logical variable being expressed as x₂ and the second logical variable being expressed as x₃. A lower bound value min(Uₗ(F, T), Uₗ(T, F)) at the node 3 that is calculated in S354 by the calculation unit 120 is 20. At this time, the difference of 15 (15−0) between the overall upper bound value UB and the overall lower bound value LB₃ at the node 3 is equal to or less than the lower bound value, and hence the replacement unit 130 executes a simplification process of replacing the first logical variable x₂ with the second logical variable x₃ at the node 3.

FIG. 10 illustrates an example of the second simplification process according to the present embodiment. The horizontal axis in FIG. 10 represents the sum of the weights of the clauses that each become false, of the clauses included in the overall original problem. LB in FIG. 10 represents the overall lower bound value for the child problem as the processing target, and UB therein represents the overall upper bound value. Uₗ(X, Y) represents a lower bound value of the weight sum of the clauses of the child problem that each become false in the case of assigning the logical value X to the first logical variable x and assigning the logical value Y to the second logical variable y in the child problem.

The overall lower bound value LB is a lower bound value of the weight sum of the clauses that each become false (take the first logical value) for the overall problem at the nodes of the child problem as the processing targets. The minimum value of Uₗ(T, F) and Uₗ(F, T) is a value of the weight sum of the clauses that each become false in the best case at the time of assigning the same logical value to the first logical variable and the second logical variable in the child problems.

Accordingly, the sum of the overall lower bound value LB and the minimum value of the lower bound values Uₗ(T, F) and Uₗ(F, T) is the weight sum of the first logical value for the overall problem that is obtained in the best case at the time of respectively assigning different logical values to the first logical variable and the second logical variable in the child problem as the processing targets. In the example of FIG. 9, the sum of the overall lower bound value LB and the minimum value of the lower bound values Uₗ(T, F) and Uₗ(F, T) is 20 (0+20).

Meanwhile, the overall upper bound value UB is an upper bound value of the weight sum of the clauses that each become false (take the first logical value) for the overall problem (that is, the weight sum of the clauses that each become false, the weight sum being estimated to be obtained even in the worst case), which is known so far as a result of processing the child problem. Accordingly, in the case where the overall upper bound value UB is larger than the sum of the overall lower bound value LB and the minimum value of the lower bound values Uₗ(T, F) and Uₗ(F, T), a solution better than known one cannot be obtained even if different logical values are respectively assigned to the first logical variable and the second logical variable. Hence, the same logical variable may be assigned to the first logical variable and the second logical variable.

In the example of FIG. 9, at the time of processing the child problem at the node 3, the overall upper bound value UB is 15, which is larger than the sum of the overall lower bound value LB and the minimum value of the lower bound values Uₗ(T, F) and Uₗ(F, T), that is, 20. Accordingly, in this case, the replacement unit 130 may assign the same logical variable to the first logical variable and the second logical variable in the child problem at the node 3 to generate a child problem at a node 4.

In this way, according to the processing apparatus 10 of the present embodiment, a simplification process of replacing one logical variable with another logical variable can be executed in addition to conventional Inference Rules whose target is a single logical variable. Hence, child problem can be more considerably simplified, and a processing load of a maximum satisfiability problem can be reduced. In particular, according to the present embodiment, a maximum cut problem and the like having a weight that varies greatly can be more efficiently solved. Note that, in the above-mentioned embodiment, the first logical value is “false”, the second logical value is “true”, and the predetermined logical relation is “equal relation”, but the present invention is not limited to these definitions. For example, the first logical value may be “true”, the second logical value may be “false”, and/or the predetermined logical relation may be “unequal relation”.

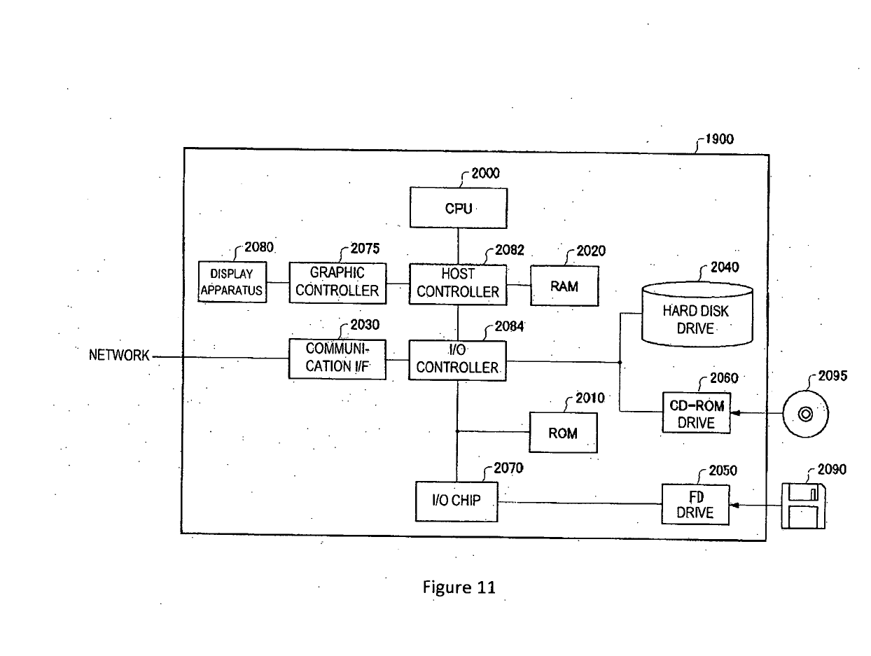

FIG. 11 illustrates an example of a hardware configuration of a computer 1900 that functions as the processing apparatus 10. The computer 1900 according to the present embodiment includes: a CPU peripheral unit including a CPU 2000, a RAM 2020, a graphic controller 2075, and a display apparatus 2080 that are connected to one another by a host controller 2082; an input/output unit including a communication interface 2030, a hard disk drive 2040, and a CD-ROM drive 2060 that are connected to the host controller 2082 by an input/output controller 2084; and a legacy input/output unit including a ROM 2010, a flexible disk drive 2050, and an input/output chip 2070 that are connected to the input/output controller 2084.

The host controller 2082 connects the RAM 2020 to the CPU 2000 and the graphic controller 2075 that access the RAM 2020 at a high transfer rate. The CPU 2000 operates on the basis of programs stored in the ROM 2010 and the RAM 2020, and controls the respective units. The graphic controller 2075 acquires image data that is generated by the CPU 2000 or the like on a frame buffer provided in the RAM 2020, and displays the image data on the display apparatus 2080. Alternatively, the frame buffer for storing the image data generated by the CPU 2000 or the like may be provided in the graphic controller 2075.

The input/output controller 2084 connects the host controller 2082 to the communication interface 2030, the hard disk drive 2040, and the CD-ROM drive 2060 that are relatively high-speed input/output apparatuses. The communication interface 2030 communicates with other apparatuses wiredly or wirelessly via a network. Moreover, the communication interface functions as hardware that makes communications. The hard disk drive 2040 stores therein programs and data used by the CPU 2000 in the computer 1900. The CD-ROM drive 2060 reads programs or data out of a CD-ROM 2095, and provides the programs or data to the hard disk drive 2040 via the RAM 2020.

Moreover, the ROM 2010, the flexible disk drive 2050, and relatively low-speed input/output apparatuses of the input/output chip 2070 are connected to the input/output controller 2084. The ROM 2010 stores therein a boot program executed at the time of activation of the computer 1900 and/or programs depending on hardware of the computer 1900. The flexible disk drive 2050 reads programs or data out of a flexible disk 2090, and provides the programs or data to the hard disk drive 2040 via the RAM 2020. The input/output chip 2070 connects the flexible disk drive 2050 to the input/output controller 2084, and connects various input/output apparatuses to the input/output controller 2084 via, for example, a parallel port, a serial port, a keyboard port, and a mouse port.

The programs that are provided to the hard disk drive 2040 via the RAM 2020 are used by a user while being stored in a recording medium such as the flexible disk 2090, the CD-ROM 2095, or an IC card. The programs are read out of the recording medium, are installed on the hard disk drive 2040 in the computer 1900 via the RAM 2020, and are executed by the CPU 2000.

Programs that are installed on the computer 1900 and cause the computer 1900 to function as the processing apparatus 10 include a problem acquiring module, a calculation module, a replacement module, a determination module, a problem generating module, a solution generating module, and an output module. The programs or the modules may act on the CPU 2000 and the like to cause the computer 1900 to function as the problem acquiring unit 110, the calculation unit 120, the replacement unit 130, the determination unit 140, the child problem generating unit 150, the solution generating unit 160, and the output unit 190.

Information processing described in the programs is read onto the computer 1900 to thereby function as the problem acquiring unit 110, the calculation unit 120, the replacement unit 130, the determination unit 140, the child problem generating unit 150, the solution generating unit 160, and the output unit 190 that are specific means achieved by cooperation of software and the above-mentioned various hardware resources. Then, information computing or working suited to an intended use of the computer 1900 according to the present embodiment is achieved by these specific means, whereby a special processing apparatus 10 suited to the intended use is constructed.

As an example, in the case where the computer 1900 communicates with an external apparatus or the like, the CPU 2000 executes a communication program loaded on the RAM 2020, and instructs the communication interface 2030 to perform a communication process, on the basis of a processing content described in the communication program. Under the control of the CPU 2000, the communication interface 2030 reads out transmission data stored in a transmission buffer area or the like provided on a storage device such as the RAM 2020, the hard disk drive 2040, the flexible disk 2090, or the CD-ROM 2095, and transmits the transmission data to the network, or the communication interface 2030 writes reception data received from the network into a reception buffer area or the like provided on the storage device. In this way, the communication interface 2030 may transfer transmission/reception data with the storage device according to a direct memory access (DMA) method. Alternatively, the CPU 2000 may read data out of the transfer-source storage device or communication interface 2030, and may write the data into the transfer-destination communication interface 2030 or storage device, to thereby transfer the transmission/reception data.

Moreover, the CPU 2000 reads, onto the RAM 2020, the entirety or a necessary portion of files, databases, or the like stored in an external storage device such as the hard disk drive 2040, the CD-ROM drive 2060 (CD-ROM 2095), and the flexible disk drive 2050 (flexible disk 2090) through DMA transfer or the like, and performs various processes on data on the RAM 2020. Then, the CPU 2000 writes the processed data back into the external storage device through DMA transfer or the like. In such a process, the RAM 2020 can be considered to temporarily hold the contents of the external storage device, and hence the RAM 2020, the external storage device, and the like are collectively referred to as a memory, a storage unit, a storage device, or the like in the present embodiment. For example, the storage unit of the processing apparatus 10 may store therein data received from/provided to the problem acquiring unit 110, the calculation unit 120, the replacement unit 130, the determination unit 140, the child problem generating unit 150, the solution generating unit 160, and the output unit 190, as appropriate. For example, the storage unit may receive and store therein data that is inputted to the calculation unit 120 by the feature vector problem acquiring unit 110. Moreover, the storage unit may store therein the child problems and the like calculated by the child problem generating unit 150.

Various pieces of information in various programs, pieces of data, tables, databases, and the like in the present embodiment are stored in the storage device as described above to become information processing targets. Note that the CPU 2000 may hold part of the RAM 2020 on a cache memory, and may read and write data on the cache memory. Even in such a mode, the cache memory serves as part of the function of the RAM 2020, and hence, in the present embodiment, the cache memory is also included in the RAM 2020, the memory, and/or the storage device unless distinctively defined.

Moreover, the CPU 2000 performs, on data read out of the RAM 2020, various processes including various computing, information working, condition determination, and information retrieval/replacement described in the present embodiment, which are designated by a command sequence of a program, and writes the data back into the RAM 2020. For example, in the case of making condition determination, the CPU 2000 determines whether or not a condition that various variables described in the present embodiment are more than, less than, equal to or more than, equal to or less than, or equal to another variable or constant is satisfied. In the case where the condition is established (or not established), the CPU 2000 proceeds to a different command sequence, or invokes a sub-routine.

Moreover, the CPU 2000 can retrieve information stored in files, databases, or the like in the storage device. For example, in the case where a plurality of entries in each of which an attribute value having a second attribute is associated with an attribute value having a first attribute are stored in the storage device, the CPU 2000 retrieves an entry in which the attribute value having the first attribute is coincident with a designated condition, from among the plurality of entries stored in the storage device, and reads out the attribute value having the second attribute stored in the retrieved entry, whereby the CPU 2000 can obtain the attribute value having the second attribute associated with the first attribute that satisfies the designated condition.

In the case where a plurality of elements are listed in the above-mentioned embodiment, elements other than the listed elements may be used. For example, in the case where it is described that “X executes Y using A, B, and C”, X may execute Y using D in addition to A, B, and C.

Hereinabove, the present invention has been described by way of the embodiment, but the technical range of the present invention is not limited to the range described above in the embodiment. It is obvious to those skilled in the art that various changes or improvements can be added to the above-mentioned embodiment. It is obvious from the scope of claims that modes to which such changes or improvements are added can also be included in the technical range of the present invention.

It should be noted that the execution order of processes such as operations, procedures, steps, and stages in apparatuses, systems, programs, and methods described in the scope of claims, the description, and the drawings can be achieved as an arbitrary order unless “earlier than”, “prior to”, and the like are specially clarified or unless an output in the previous process is used in the subsequent process. Even if operation flows in the scope of claims, the description, and the drawings are described using “first”, “subsequently”, and the like for convenience sake, execution in the order indicated by these terms is not meant to be essential.

### Non-Limiting Examples

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A processing apparatus comprising:
a problem acquiring unit for accessing a problem for maximizing a sum of weights respectively associated with clauses that each take a predetermined logical value, of a plurality of clauses each based on at least one logical variable;
a calculation unit for calculating a boundary value of the sum of the weights in a case where it is assumed that a first logical variable and a second logical variable have a predetermined logical relation; and
a replacement unit for replacing the first logical variable in each of the plurality of clauses with a logical expression formed by using the second logical variable, in a case where the boundary value satisfies a predetermined condition.

2. The processing apparatus according to claim 1, wherein
the calculation unit calculates a lower bound value of a sum of weights respectively associated with clauses that each take the first logical value in a case where it is assumed that the first logical variable and the second logical variable have a predetermined logical relation,
the calculation unit calculates an upper bound value of a sum of weights respectively associated with clauses that each take the first logical value in a case where it is assumed that the first logical variable and the second logical variable do not have the predetermined logical relation, and
in a case where the upper bound value is equal to or less than the lower bound value, the replacement unit replaces the first logical variable with the logical expression in the case where the first logical variable and the second logical variable do not have the predetermined logical relation.

3. The processing apparatus according to claim 2, wherein
the calculation unit calculates, as the upper bound value, a sum of weights respectively associated with clauses that can become false in the case where the first logical variable and the second logical variable do not have the predetermined logical relation,
the calculation unit calculates, as the lower bound value, a sum of weights respectively associated with clauses that always become false in the case where the first logical variable and the second logical variable have the predetermined logical relation, and
the processing apparatus processes a problem for assigning a logical value to the logical variables so as to maximize a sum of weights of clauses that each become true, of the plurality of clauses.

4. The processing apparatus according to claim 2, wherein
the calculation unit calculates the upper bound value in a case where the first logical variable and the second logical variable are equal to each other,
the calculation unit calculates the lower bound value in a case where the first logical variable and the second logical variable are not equal to each other, and
in the case where the upper bound value is equal to or less than the lower bound value, the replacement unit replaces the first logical variable in each of the plurality of clauses with the second logical variable.

5. The processing apparatus according to claim 2, wherein
the calculation unit calculates, as the lower bound value, a minimum value of respective lower bound values in combinations of values of the first logical variable and the second logical variable having the predetermined logical relation, and
the calculation unit calculates, as the upper bound value, a minimum value of respective upper bound values in combinations of values of the first logical variable and the second logical variable not having the predetermined logical relation.

6. The processing apparatus according to claim 5, wherein
the calculation unit calculates a first value by subtracting a sum of: a total of weights of clauses including a logical sum of the first logical variable and the second logical variable; a total of weights of clauses including a logical sum of a negation of the first logical variable and the second logical variable; and a total of weights of clauses including a logical sum of a negation of the second logical variable and the first logical variable, from a sum of: a total of weights of clauses including the first logical variable; and a total of weights of clauses including the second logical variable,
the calculation unit calculates a second value by subtracting a sum of: a total of weights of clauses including a logical sum of the negation of the first logical variable and the negation of the second logical variable; the total of the weights of the clauses including the logical sum of the negation of the first logical variable and the second logical variable; and the total of the weights of the clauses including the logical sum of the negation of the second logical variable and the first logical variable, from a sum of: a total of weights of clauses including the negation of the first logical variable; and a total of weights of clauses including the negation of the second logical variable, and
the calculation unit defines a smaller one of the first value and the second value, as the upper bound value.

7. The processing apparatus according to claim 5, wherein
the calculation unit calculates a third value that is a sum of: a total of weights of clauses that are a negation of the first logical variable; a total of weights of clauses that are a second logical variable; and a total of weights of clauses that are the logical sum of a negation of the first logical variable and the second logical variable,
the calculation unit calculates a fourth value that is a sum of: a total of weights of clauses that are the first logical variable; a total of weights of clauses that are a negation of the second logical variable; and a total of weights of clauses that are a logical sum of a negation of the second logical variable and the first logical variable, and
the calculation unit defines a smaller one of the third value and the fourth value, as the lower bound value.

8. The processing apparatus according to claim 1, further comprising a child problem generating unit for selecting one logical variable from a plurality of logical variables included in the plurality of clauses and generating a child problem not including the selected logical variable on a basis of a result of assigning a logical value to the selected logical variable, and
the calculation unit calculates the boundary value for combinations of the logical variables included in the child problem.

9. The processing apparatus according to claim 8, wherein
the calculation unit calculates an overall lower bound value that is a lower bound that can be taken by a value of the sum of the weights of the plurality of clauses for an overall problem that takes the predetermined logical value for the child problem, and
the calculation unit calculates an overall upper bound value that is an upper bound that can be taken by a value of the sum of the weights of the plurality of clauses for the overall problem.

10. The processing apparatus according to claim 8, wherein
the calculation unit calculates, for the child problem, a lower bound value of the sum of the weights respectively associated with the clauses that each take the first logical value in the case where it is assumed that the first logical variable and the second logical variable have the predetermined logical relation, and
the replacement unit replaces the first logical variable in each of the plurality of clauses with the logical expression in the case where the first logical variable and the second logical variable do not have the predetermined logical relation, on a basis of a result of comparing a difference between the overall upper bound value and the overall lower bound value with the lower bound value.

11. The processing apparatus according to claim 10, wherein
in a case where the difference between the overall upper bound value and the overall lower bound value is equal to or less than the lower bound value, the replacement unit replaces the first logical variable in each of the plurality of clauses with the logical expression in the case where the first logical variable and the second logical variable do not have the predetermined logical relation.

12. The processing apparatus according to claim 1, processing a problem including a plurality of clauses and being equivalent to a maximum cut problem.

13. A computer-implemented processing method comprising:
accessing a problem for maximizing or minimizing a sum of weights respectively associated with clauses that each take a predetermined logical value, of a plurality of clauses each based on at least one logical variable, the processing method
calculating a boundary value of the sum of the weights in a case where it is assumed that a first logical variable and a second logical variable have a predetermined logical relation; and
replacing the first logical variable in each of the plurality of clauses with a logical expression formed by using the second logical variable, in a case where the boundary value satisfies a predetermined condition.

14. The computer-implemented processing method according to claim 13, wherein
the calculating calculates a lower bound value of a sum of weights respectively associated with clauses that each take the first logical value in a case where it is assumed that the first logical variable and the second logical variable have a predetermined logical relation,
the calculating calculates an upper bound value of a sum of weights respectively associated with clauses that each take the first logical value in a case where it is assumed that the first logical variable and the second logical variable do not have the predetermined logical relation, and
in a case where the upper bound value is equal to or less than the lower bound value, replacing the first logical variable with the logical expression in the case where the first logical variable and the second logical variable do not have the predetermined logical relation.

15. The computer-implemented processing method according to claim 14, wherein
the calculating calculates, as the upper bound value, a sum of weights respectively associated with clauses that can become false in the case where the first logical variable and the second logical variable do not have the predetermined logical relation,
the calculating calculates, as the lower bound value, a sum of weights respectively associated with clauses that always become false in the case where the first logical variable and the second logical variable have the predetermined logical relation, and
processing a problem for assigning a logical value to the logical variables so as to maximize a sum of weights of clauses that each become true, of the plurality of clauses.

16. The computer-implemented processing method according to claim 14, the calculating calculates an upper bound value in a case where the first logical variable and the second logical variable are equal to each other,
the calculating calculates a lower bound value in a case where the first logical variable and the second logical variable are not equal to each other, and
in the case where the upper bound value is equal to or less than the lower bound value, replacing the first logical variable in each of the plurality of clauses with the second logical variable.

17. The computer-implemented processing method according to claim 13, wherein
the calculating calculates, as the lower bound value, a minimum value of respective lower bound values in combinations of values of the first logical variable and the second logical variable having the predetermined logical relation, and
the calculating calculates, as the upper bound value, a minimum value of respective upper bound values in combinations of values of the first logical variable and the second logical variable not having the predetermined logical relation.

18. The computer-implemented processing method according to claim 17, wherein
the calculating calculates a first value by subtracting a sum of: a total of weights of clauses including a logical sum of the first logical variable and the second logical variable; a total of weights of clauses including a logical sum of a negation of the first logical variable and the second logical variable; and a total of weights of clauses including a logical sum of a negation of the second logical variable and the first logical variable, from a sum of: a total of weights of clauses including the first logical variable; and a total of weights of clauses including the second logical variable,
the calculating calculates a second value by subtracting a sum of: a total of weights of clauses including a logical sum of the negation of the first logical variable and the negation of the second logical variable; the total of the weights of the clauses including the logical sum of the negation of the first logical variable and the second logical variable; and the total of the weights of the clauses including the logical sum of the negation of the second logical variable and the first logical variable, from a sum of: a total of weights of clauses including the negation of the first logical variable; and a total of weights of clauses including the negation of the second logical variable, and
the calculating calculates defines a smaller one of the first value and the second value, as the upper bound value.

19. The computer-implemented processing method according to claim 17, wherein
the calculating calculates a third value that is a sum of: a total of weights of clauses that are a negation of the first logical variable; a total of weights of clauses that are the second logical variable; and a total of weights of clauses that are a logical sum of the negation of the first logical variable and the second logical variable,
the calculating calculates a fourth value that is a sum of: a total of weights of clauses that are the first logical variable; a total of weights of clauses that are the negation of the second logical variable; and a total of weights of clauses that are the logical sum of a negation of the second logical variable and the first logical variable, and
the calculation unit defines a smaller one of the third value and the fourth value, as the lower bound value.

20. A non-transitory computer program product for calculating a hash value comprising a computer readable storage medium having computer readable program code embodied therewith, the computer readable program code configured to perform:
accessing a problem for maximizing or minimizing a sum of weights respectively associated with clauses that each take a predetermined logical value, of a plurality of clauses each based on at least one logical variable;
calculating a boundary value of the sum of the weights in a case where it is assumed that a first logical variable and a second logical variable have a predetermined logical relation; and
replacing the first logical variable in each of the plurality of clauses with a logical expression formed by using the second logical variable, in a case where the boundary value satisfies a predetermined condition.
